(19) United States
(12) Patent Application Publication
(10) Pub. No.: US 2016/0120138 A1
(43) Pub. Date: May 5, 2016

(54) Dual Plant Stake and Watering Apparatus

(71) Applicant: Curt Hummel, Cypress, TX (US)

(72) Inventor: Curt Hummel, Cypress, TX (US)

(21) Appl. No.: 14/528,428

(22) Filed: Oct. 30, 2014

(51) Int. Cl. A01G 17/04; A01G 29/00

(52) U.S. Cl. CPC A01G 17/04; A01G 29/00

(57) ABSTRACT

An apparatus configured for stabilizing a plant and watering roots of a plant is disclosed. The apparatus comprises first and second hollow tubular member. A portion of the first tubular member is adapted to be placed underground. The second tubular member comprises at least two orifices.

The tubular members are connected to an angular connector and form an angle between each other. The angular connector comprises an open end adaptable to receive water from a water supply.

An inner tubular member is slidably disposed within the second tubular member and comprises at least two orifices. The orifices of the second tubular member and the inner tubular member may receive an adjustable stabilizer.

A plant terminus on the inner tubular member partially encompasses a plant trunk and comprises at least one orifice. At least one second adjustable stabilizer circumnavigates the plant terminus and plant trunk to keep the plant aligned.

### CROSS-REFERENCE TO RELATED APPLICATIONS

N/A

### FIELD OF THE INVENTION

The present disclosure relates to a dual plant stake and watering apparatus, more specifically a plant stake and watering apparatus that may be hollow and may be capable of stabilizing the plant as well as applying water to the plant's roots.

### BACKGROUND OF THE INVENTION

The disclosed subject matter provides a dual tree stake and watering apparatus. A portion of the apparatus may be disposed around the circumference of a plant in order to provide support to the plant. The apparatus may further provide water to the roots of a plant.

### BRIEF SUMMARY OF THE INVENTION

The disclosure provides a dual plant stake and watering apparatus. In one preferred embodiment, the apparatus comprises a first hollow tubular member and a second hollow tubular member. The first and second tubular members comprise a first and second end, wherein at least one of the first and second ends of the first tubular member is adaptable to exist in an underground environment. The second tubular member may further comprise at least two orifices.

A first and second portion of an angular connector may be adapted to receive one of the first or second ends of the first tubular member and one of the first or second ends of the second tubular member. When the first or second ends of the first and second tubular members are displaced within portions of the angular connector, an angle is made between the first and second tubular members. In certain embodiments, the angle may roughly resemble a right angle. The angular connector may further comprise an open end that is adaptable to receive water from a water supply, such as, but not limited to a hose.

An inner tubular member comprising a distal end and a proximal end may be slidably disposed within the second tubular member in the axial direction of the second tubular member. Due to the placement of the inner tubular member, the inner tubular member may act as an “extension” of the second tubular member. The inner tubular member may further include at least two orifices. A first adjustable stabilizer may be disposed through the orifices of the inner tubular member and the second tubular member in order to restrict the axial movement of the inner tubular member.

A plant terminus may be supported by the proximal end of the inner tubular member. The plant terminus may be placed in a position adjacent to a plant trunk and may touch or not touch the plant trunk. The plant terminus comprises at least one orifice in order to allow for at least one second adjustable stabilizer to be disposed through the at least one orifice and around the plant trunk so as to keep the plant terminus and the plant trunk in close proximity. A purpose of the second adjustable stabilizer is to keep the plant trunk aligned.

These and other aspects of the disclosed subject matter, as well as additional novel features, will be apparent from the description provided herein. The intent of this summary is not to be a comprehensive description of the subject matter, but rather to provide a short overview of some of the subject matter's functionality. Other systems, methods, features and advantages here provided will become apparent to one with skill in the art upon examination of the following FIGURES and detailed description. It is intended that all such additional systems, methods, features and advantages that are included within this description, be within the scope of any claims filed later.

### BRIEF DESCRIPTION OF THE DRAWINGS

The novel features believed characteristic of the disclosed subject matter will be set forth in any claims that are filed later. The disclosed subject matter itself, however, as well as a preferred mode of use, further objectives, and advantages thereof, will best be understood by reference to the following detailed description of an illustrative embodiment when read in conjunction with the accompanying drawings, wherein:

FIG. 1 displays an embodiment of a schematic diagram of the plant stake/watering apparatus.

FIG. 2 displays an embodiment of the assembled plant stake/watering apparatus providing support to a plant.

FIG. 3A displays an embodiment of a second tubular member/angular connector combination and inner tubular member/plant terminus combination.

FIG. 3B displays an embodiment of the inner tubular member/plant terminus combination being disposed within the second tubular member/angular connector combination.

FIG. 4A displays an embodiment of the second tubular member and inner tubular member comprising orifices.

FIG. 4B displays an embodiment of the second tubular member with an adjustable member disposed through an orifice on the second tubular member.

FIG. 5 displays an embodiment of the plant terminus existing adjacent a plant.

### DETAILED DESCRIPTION OF ILLUSTRATIVE EMBODIMENTS

Reference now should be made to the drawings, in which the same reference numbers are used throughout the different 100 figures to designate the same components.

It will be understood that, although the terms first, second, third, etc. may be used herein to describe various elements, these elements should not be limited by these terms. These terms are only used to distinguish one element from another element. Thus, a first element discussed below could be termed a second element without departing from the teachings of the present disclosure.

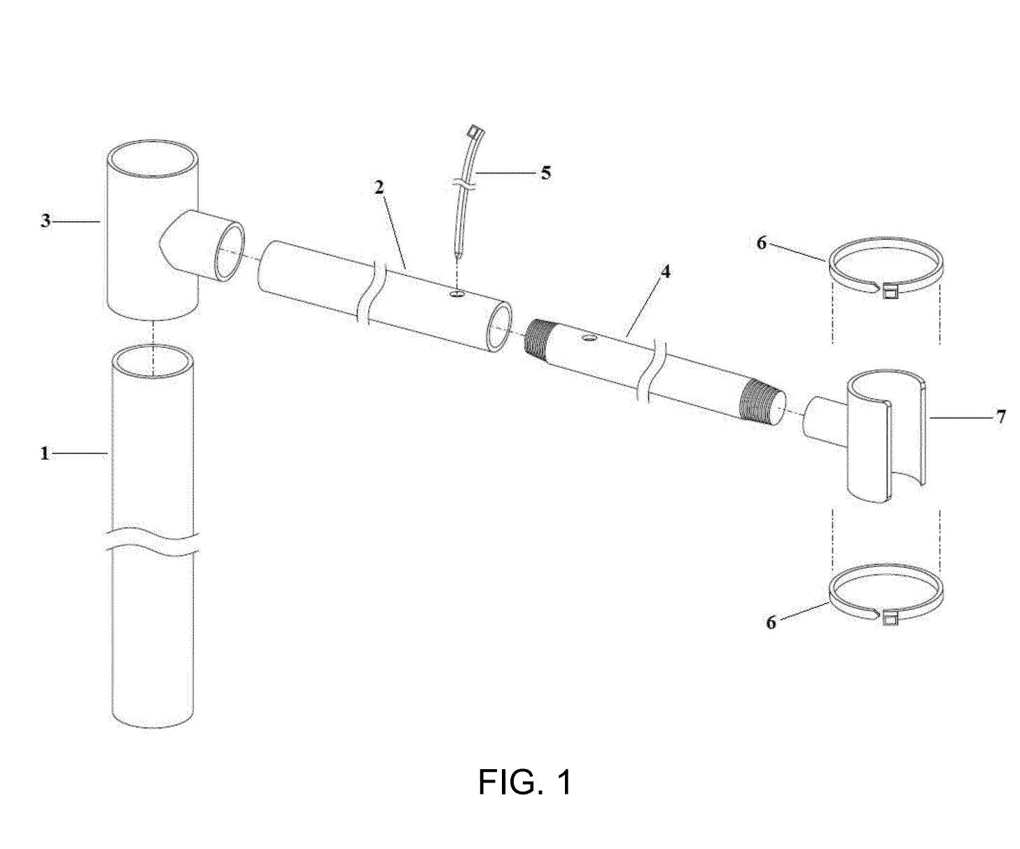

FIG. 1 displays an embodiment of a schematic diagram of the plant stake/watering apparatus. The apparatus comprises seven main components: a first tubular member 1, a second tubular member 2, an angular connector 3, an inner tubular member 4, a first adjustable member 5, a second adjustable member 6, and a plant terminus 7.

The first tubular member 1 and second tubular member 2 are hollow and comprise first and second ends. The first tubular member 1 may be hollow in order to allow for a portion of the first tubular member 1 to be forced into the ground and to allow water from a water supply to flow through the hollow space and into the ground. The first tubular member 1 may be made of a material adaptable to exist in an underground environment, such as, but not limited to a metal or high density polymer. The second tubular member 2 may be hollow in order to allow for the inner tubular member 4 to be disposed within the hollow area. According to FIG. 1, the diameter of the first tubular member 1 is shown to be larger than the second tubular member 2. In other embodiments, the second tubular member 2 may be larger in diameter than the first tubular member 1 or the diameters of both first and second tubular members 1,2 may be the same. The second tubular member 2 may further comprise two orifices in order to allow for one of the adjustable members 5,6 to be disposed through the orifices.

In other embodiments, the second tubular member 2 may comprise more than two orifices in order to allow for one of the adjustable members 5,6 to be disposed in different configurations through the orifices or in order to allow for more than one of the adjustable members 5,6 to be disposed through the orifices.

First and second portions of an angular connector 3 may be adapted to receive one of the first or second ends of the first tubular member 1 and one of the first or second ends of the second tubular member 2. When the first or second ends of the first and second tubular members 1,2 are displaced within portions of the angular connector 3, an angle is made between the first and second tubular members 1,2. In certain embodiments, the angle may roughly resemble a right angle. In other embodiments, the angle may be an angle other than a right angle. The angular connector 3 may further comprise an open end that is adaptable to receive water from a water supply, such as, but not limited to a hose. In other embodiments, the first or second ends of the first and second tubular members 1,2 may screw into threads found on the interior of the angular connector 3. In other embodiments, a portion of the angular connector may be disposed within a portion of the first tubular member 1.

The inner tubular member 4 comprises a distal end and a proximal end. The inner tubular member 4 may be slidably disposed within the second tubular member 2 in the axial direction of the second tubular member 2. Due to the placement of the inner tubular member 4, the inner tubular member 4 may act as an “extension” of the second tubular member 2. The inner tubular member 4 may be made of a material so as to keep its integrity no matter how much of the inner tubular member 4 is disposed outside of the hollow section of the second tubular member 2. The inner tubular member 4 may further include at least two orifices. A first adjustable member 5 may be disposed through the orifices of the inner tubular member 4 and the second tubular member 2 in order to restrict the axial movement of the inner tubular member 4. In a certain embodiment, the orifices of each of the inner tubular member 4 and the second tubular member 2 may exist on opposite sides of the diameters of the inner tubular member 4 and the second tubular member 2, respectively. The first adjustable member 5 may then penetrate the orifices and wrap around a side of the second tubular member 2. It is preferred in most embodiments that the orifices found in the second tubular member 2 and the inner tubular member 4 may at least partially align in order to allow for the first adjustable member 5 to penetrate the orifices.

A plant terminus 7 may be supported by the proximal end of the inner tubular member 4. In a certain embodiment, a portion of the plant terminus 7 may screw into threads on the interior diameter of the inner tubular member 4. The plant terminus 7 may comprise a half semicylindrical section that may be placed in a position adjacent to a plant trunk and may touch or may not touch the plant trunk. The plant terminus 7 may further comprise at least one orifice in order to allow for at least one second adjustable member 6 to be disposed through the at least one orifice and around the plant trunk so as to keep the plant terminus 7 and the plant trunk in close proximity. A purpose of the second adjustable member 6 is to keep the plant trunk aligned. In certain embodiments, the second adjustable member 6 may or may not cause the plant terminus 7 to touch the plant trunk.

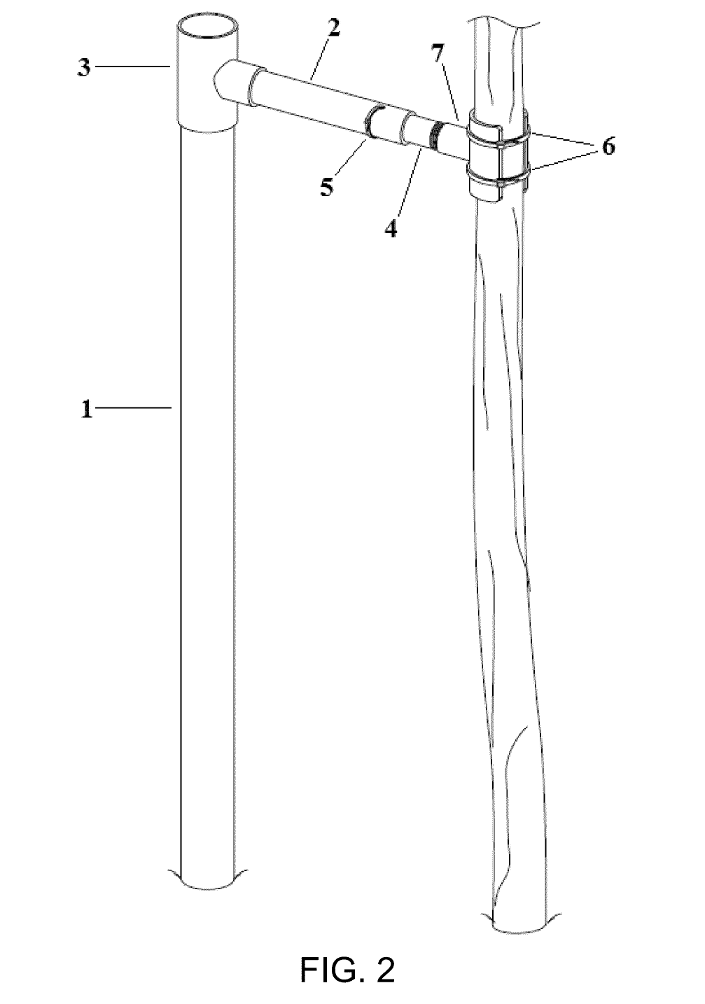

FIG. 2 displays an embodiment of the assembled plant stake/watering apparatus providing support to a plant. The first tubular member 1 is shown with a portion of the first tubular member 1 being disposed in the ground, which is ideally where the roots of the plant may exist. The open section found on a side of the angular connector 3 allows for water to flow to the ground and subsequently penetrate the ground in order to reach the roots of a plant.

The angular connector can be seen engaging both the first tubular member 1 and second tubular member 2. Both tubular members make roughly a right angle in the embodiment shown in FIG. 2. A portion of the inner tubular member 4 may be found at the end of the second tubular member 2. This portion of the inner tubular member 4 is shown supporting the plant terminus 7, which is in close proximity with the plant and in engagement with the second adjustable stabilizer 6 to stay in close proximity with the plant. The assembled plant stake/watering embodies a simplistic structure that helps to stabilize plants.

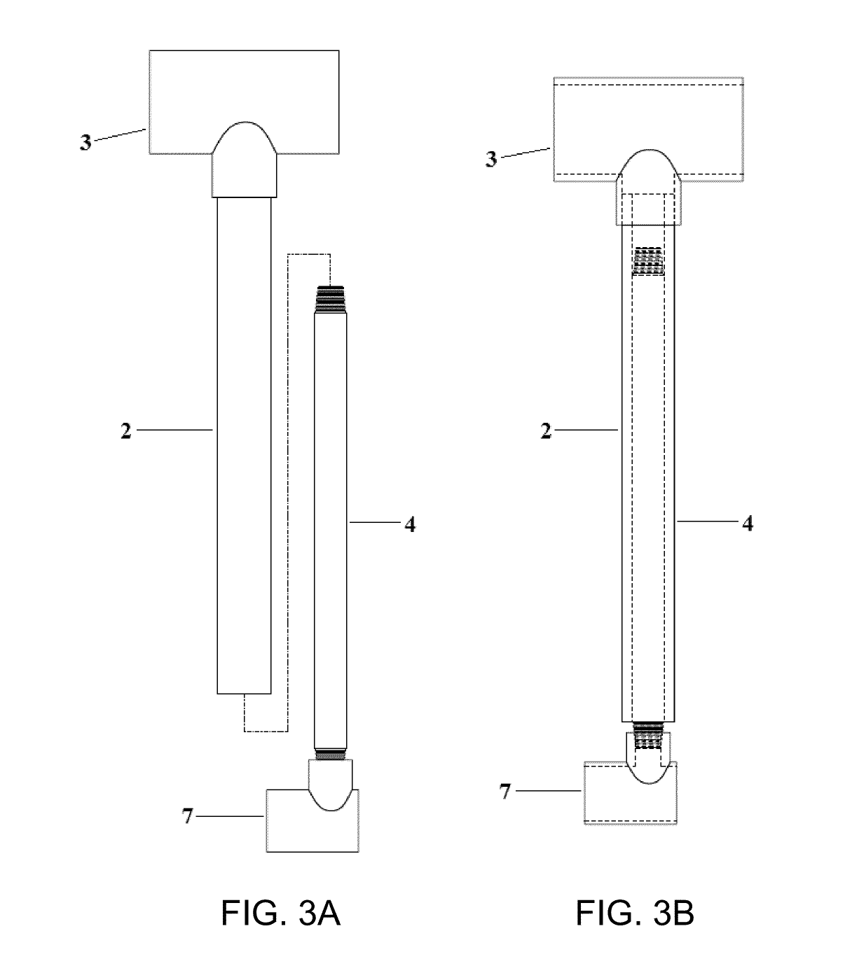

FIG. 3A displays an embodiment of a second tubular member 2/angular connector combination and inner tubular member 4/plant terminus 7 combination. The second tubular member 2 is shown attached to the angular connector 3. In certain embodiments, the second tubular member 2 is screwed into threads found within the angular connector 3, or vice versa. The inner tubular member 4 is shown attached to the plant terminus 7. In certain embodiments, the inner tubular member 4 is screwed into threads found within the plant terminus 7, or vice versa.

FIG. 3B displays an embodiment of the inner tubular member 4/plant terminus 7 combination being disposed within the second tubular member 2/angular connector 3 combination. The outer diameter of the inner tubular member 4 may preferably be smaller than the interior diameter of the second tubular member 2. In certain embodiments, a portion of the angular connector 3 may be disposed within a portion of the second tubular member 2. In other embodiments, a portion of plant terminus 7 may be disposed within a portion of the inner tubular member 4.

In another embodiment, the inner tubular member 4 may comprise one or more orifices or indents that may penetrate one or more protrusions that may exist within the hollow section of the second tubular member 2. In order for the inner tubular member 4 to slide into the second tubular member 2, a section of the inner tubular member 4 may be shaped as an indentation of the shape of the one or more protrusions of the second tubular member 2 (this indentation may be continuous along a length of the inner tubular member 4. The one or more orifices or indents of the inner tubular member 4 may exist adjacent the indentation section of the inner tubular member 4. When the inner tubular member 4 is placed into the second tubular member 2, the protrusions may exist within the indentation section of the inner tubular member 4. In order to secure the inner tubular member 4 within the second tubular member 2, the inner tubular member 4 may be twisted so that the one or more protrusions of the second tubular member 2 may move into the one or more orifices or indents of the inner tubular member 4. Similar securing means may be utilized between the first tubular member 1 and the angular connector 3, the second tubular member 2 and the angular connector 3, and/or the inner tubular member 4 and the plant terminus 7.

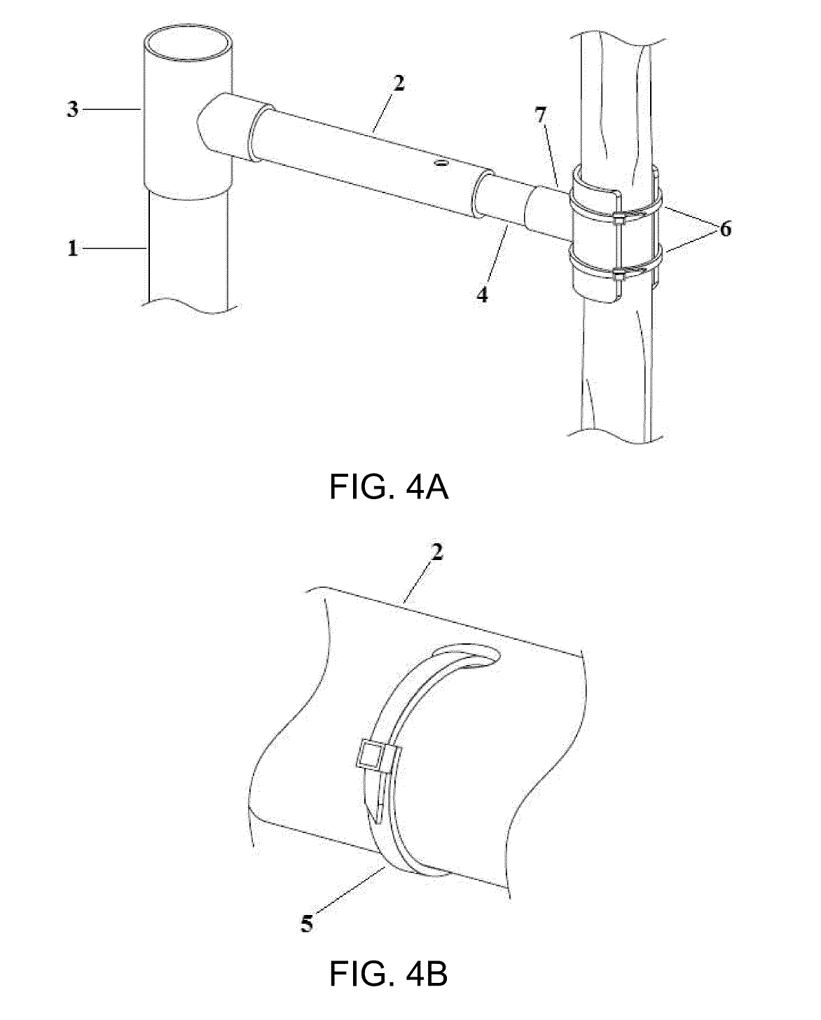

FIG. 4A displays an embodiment of the second tubular member 2 and inner tubular member 4 comprising orifices (the orifices of the inner tubular member 4 is not shown). The orifices may be created when the inner tubular member 4 is not disposed within the second tubular member 2 or when the inner tubular member 4 is disposed within the second tubular member 2. One way in which the orifices may be created is through the use of a drill.

A first adjustable member 5 may be disposed through the orifices of the inner tubular member 4 and the second tubular member 2 in order to restrict the axial movement of the inner tubular member 4, as shown in FIG. 4B. In a certain embodiment, the orifices of each of the inner tubular member 4 and the second tubular member 2 may exist on opposite sides of the diameters of the inner tubular member 4 and the second tubular member 2, respectively. The first adjustable member 5 may then penetrate the orifices and wrap around a side of the second tubular member 2 (as shown in FIG. 4B). It is preferred in most embodiments that the orifices found in the second tubular member 2 and the inner tubular member 4 may at least partially align in order to allow for the first adjustable member 5 to penetrate the orifices.

In another embodiment, the orifices of each of the inner tubular member 4 and the second tubular member 2 may separately exist adjacent to each other on the inner tubular member 4 and the second tubular member 2, respectively. The first adjustable member 5, in this case, may penetrate the orifices and loop through both the inner tubular member 4 and the second tubular member 2.

In another embodiment, the inner tubular member 4 may comprise one or more pressurized protrusions aligned in the axial direction of the second tubular member 2. The one or more pressurized protrusions may be adapted to penetrate one or more orifices of the second tubular member 2 in order to restrict movement of the inner tubular member 4. In certain embodiments, the one or more pressurized protrusions may be pressurized using one or more springs adapted to fit within the inner tubular member 4.

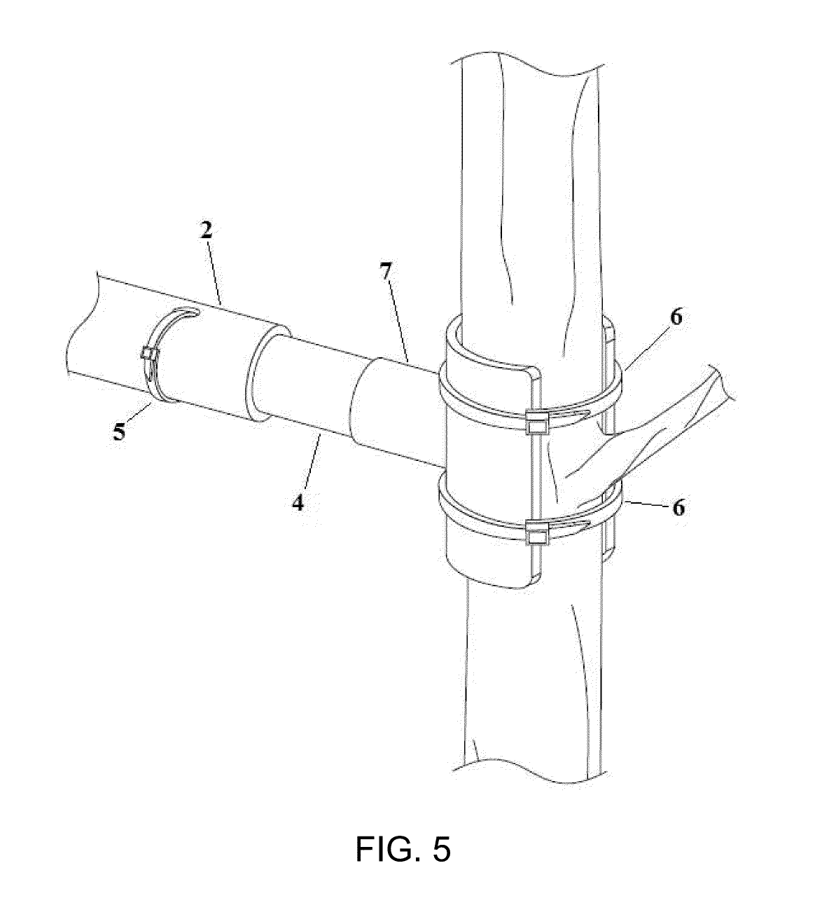

FIG. 5 displays an embodiment of the plant terminus 7 existing adjacent a plant. The plant terminus 7 may approach a plant trunk at at least one point. In certain embodiments, the point referred to may be the inner lowest point of the semicylindrical section of the plant terminus 7. The plant terminus 7 may either be in contact with the plant at the above referenced point or at one or more points of the semicylindrical section. In other embodiments, one or more of the points of the semicylindrical section may not touch the plant trunk.

In certain embodiments, the length of the semicylindrical section of the plant terminus 7 may span any length of a plant trunk. In other embodiments, a plant terminus 7 with a semicylindrical section of any length may comprise more than two orifices. These embodiments may utilize a number of second adjustable members 6 sufficient to be disposed within some or all of the orifices. A plant terminus 7 with more than one orifice and more than one second adjustable stabilizer 6 may allow for better stabilization of a plant in certain instances.

In a further embodiment, the plant stake/watering apparatus may stabilize plants other than trees such as, but not limited to bushes and vines.

In a further embodiment, one or more of the first and/or second adjustable stabilizers may not be adjustable.

Certain embodiments of the current disclosure may provide elements of the dual plant stake/watering apparatus that may be adapted to fit and or mirror plants of various sizes. For example, if a tree has a diameter of 4 inches, the plant terminus 7 and second adjustable member 6 may be sized according to the 4 inch diameter so that both elements of the dual plant stake/watering apparatus may properly carry out their specific functions.

For the purposes of this disclosure, the terms adjustable stabilizer, adjustable member, and adjustable strap are synonymous.

1. An apparatus configured for stabilizing a plant having a trunk and watering the roots of a plant having a trunk comprising:
a first tubular member comprising a hollow interior section, wherein the first tubular member comprises a first end and a second end, further wherein at least one of the first and second ends is adaptable to exist in an underground environment;
a second tubular member comprising a hollow interior section, wherein the second tubular member comprises a first end and a second end, further wherein the second tubular member comprises at least two orifices;
an angular connector, wherein a first portion of the angular connector is adapted to receive one of the first or second ends of the first tubular member and a second portion of the angular connector is adapted to receive one of the first or second ends of the second tubular member, further wherein the angular connector comprises an open end adaptable to receive water from a water supply;
an inner tubular member slidably disposed within the hollow interior section of the second tubular member comprising a distal end and a proximal end, wherein the inner tubular member is slidably disposed in the axial direction of the second tubular member, further wherein the inner tubular member comprises at least two orifices;
a first adjustable stabilizer disposed through the at least two orifices of the second tubular member and the at least two orifices of the inner tubular member;
a plant terminus supported by the proximal end of the inner tubular member configured to exist adjacent to the plant trunk, wherein the plant terminus approaches the plant trunk at at least one point, further wherein the plant terminus comprises at least one orifice; and
a second adjustable stabilizer configured to circumnavigate the plant terminus and plant trunk to keep the plant aligned, wherein the second adjustable stabilizer is disposed through the at least one orifice of the plant terminus.

2. The apparatus of claim 1, wherein at least one of the first tubular member, second tubular member, angular connector, inner tubular member, first adjustable stabilizer, plant terminus, and second adjustable stabilizer comprises polymeric material.

3. The apparatus of claim 1, wherein the first tubular member is adapted to receive water from the water supply, wherein the water may be supplied to the roots of a plant.

4. The apparatus of claim 1, wherein the angular connector is rotatably disposed around one of the first or second ends of the first tubular member.

5. The apparatus of claim 1, wherein the angular connector is rotatably disposed around one of the first or second ends of the second tubular member.

6. The apparatus of claim 1, wherein an angle exists between the first tubular member and the second tubular member when one of the first or second ends of the first tubular member and one of the first or second ends of the second tubular member are received by the angular connector.

7. The apparatus of claim 1, wherein the plant terminus is rotatably disposed around the proximal end of the inner tubular member.

8. The apparatus of claim 1, wherein a portion of the plant terminus is semicylindrical in shape.

9. The apparatus of claim 1, wherein at least one of the first adjustable stabilizer and second adjustable stabilizer is not adjustable.

10. The apparatus of claim 1, wherein the apparatus comprises more than one second adjustable stabilizer, further wherein the more than one second adjustable stabilizer penetrates more than one of the at least one orifices of the plant terminus.

11. An apparatus configured for stabilizing a plant having a trunk and watering the roots of a plant having a trunk comprising:
a first tubular member comprising a hollow interior section, wherein the first tubular member comprises a first end and a second end, further wherein one of the first and second ends is adaptable to exist in an underground environment;
a second tubular member comprising a hollow interior section, wherein the second tubular member comprises a first end and a second end, further wherein the second tubular member comprises two or more orifices aligned in the axial direction of the second tubular member;
an angular connector, wherein a first portion of the angular connector is adapted to receive one of the first or second ends of the first tubular member and a second portion of the angular connector is adapted to receive one of the first or second ends of the second tubular member, further wherein the angular connector comprises an open end adaptable to receive water from a water supply;
an inner tubular member slidably disposed within the hollow interior section of the second tubular member comprising a distal end and a proximal end, wherein the inner tubular member is slidably disposed in the axial direction of the second tubular member, further wherein the inner tubular member comprises one or more pressurized protrusions aligned in the axial direction of the second tubular member, further wherein the one or more pressurized protrusions are adapted to penetrate the two or more orifices of the second tubular member;
a plant terminus supported by the proximal end of the inner tubular member configured to exist adjacent to the plant trunk, wherein the plant terminus approaches the plant trunk at at least one point, further wherein the plant terminus comprises at least one orifice; and
an adjustable stabilizer configured to circumnavigate the plant terminus and plant trunk to keep the plant aligned, wherein the adjustable stabilizer is disposed through the at least one orifice of the plant terminus.

12. The apparatus of claim 11, wherein at least one of the first tubular member, second tubular member, angular connector, inner tubular member, plant terminus, and adjustable stabilizer comprises polymeric material.

13. The apparatus of claim 11, wherein the first tubular member is adapted to receive water from the water supply, wherein the water may be supplied to the roots of a plant.

14. The apparatus of claim 11, wherein the angular connector is rotatably disposed around one of the first or second ends of the first tubular member.

15. The apparatus of claim 11, wherein the angular connector is rotatably disposed around one of the first or second ends of the second tubular member.

16. The apparatus of claim 11, wherein an angle exists between the first tubular member and the second tubular member when one of the first or second ends of the first tubular member and one of the first or second ends of the second tubular member are received by the angular connector.

17. The apparatus of claim 11, wherein the plant terminus is rotatably disposed around the proximal end of the inner tubular member.

18. The apparatus of claim 11, wherein a portion of the plant terminus is semicylindrical in shape.

19. The apparatus of claim 11, wherein the adjustable stabilizer is not adjustable.

20. The apparatus of claim 11, wherein the apparatus comprises more than one second adjustable stabilizer, further wherein the more than one second adjustable stabilizer penetrates more than one of the at least one orifices of the plant terminus.
